(19) United States
(12) Patent Application Publication
(10) Pub. No.: US 2011/0297013 A1
(43) Pub. Date: Dec. 8, 2011

(54) PORTABLE VACUUM JUICER

(76) Inventor: Frederic Charles Sciamma, Ibiza (ES)

(21) Appl. No.: 12/595,028

(22) PCT Filed: Oct. 8, 2008
(86) PCT No.: PCT/PH2008/000008

§ 371 Date: Aug. 29, 2011

(51) Int. Cl. A23N 1/00

(52) U.S. Cl. 99/495

(57) ABSTRACT

The present invention relates to a portable vacuumable juicer that comprises of juice-extracting members (11,12) and juice-collecting receptacle member (13) having a juice-dispensing spout (14), that are characterized in that all the mentioned elements are air-tightly fitted to each other by a sealing means (15) preferably in a form of an O-ring, allowing said receptacle member (13) to be vacuumized by a vacuumizing means (16) that is preferably a detachable vacuum or air suction pump (16a) that engages and communicates with a valve means (17), preferably a one-way check valve (19), that is air-tightly fitted into the spout (14).

### TECHNICAL FIELD OF THE INVENTION

The present invention generally relates to a juicer or squeezer for extracting juices, and more particularly to a portable vacuumable juicer having a separable and vacuumable juice receptacle for purposes of an air- and oxidation-free juice storage.

### BACKGROUND OF THE INVENTION

Conventional hand-operated portable fruit juicers basically comprise complementing upper female and lower male squeezing members defining an upper compartment or chamber assembly that is fitted on a juice-collecting member thereof serving as a lower compartment or chamber. The female member serving as a cap or covering of the juicer has a generally concave or conical hollow interior that engages or communicates with a similarly shaped or profiled upstanding projecting part of the lower male member such that a pre-determined space or clearance is defined therebetween that accommodates the items to be squeezed like fruit slices. These fruit slices are pressed and twisted against the squeezing members in order to extract the juice therefrom. The hollow interior and projecting part respectively of the female and male squeezing members have opposing surface ribs functioning as juice extractors, and perforations serving as strainers allowing the juice to pass through during the squeezing or juice extracting process and fall by gravity into to the juice-collecting member. The juice-collecting member in general has a spout through which the juice can be poured out for use or consumption.

These conventional fruit juicers or the components thereof are non-airtight. Hence, the extracted juice in the juice-collecting member or receptacle is directly in contact with the surrounding air that allows contamination or oxidation process to occur affecting the freshness, taste and nutrients of the juice. Once oxidized especially in storage, the extracted juice is not desirable to drink anymore as it can be in a contaminated or altered state already that may hamper the consumer's health.

Thus, the fresh juice extracted from these conventional fruit juices, even when placed in the refrigerator, has to be consumed immediately preferably within an hour, otherwise the juice becomes sour or rancid as it is exposed to and oxidized by the surrounding air which may also further contaminate the juice by the presence of destructive organisms in the air such as bacteria, which require oxygen to survive and propagate.

### SUMMARY OF THE INVENTION

The invention seeks to overcome the drawbacks and shortcomings of the prior art by providing a means to improve the conventional portable fruit juicers such that they can be capable of preserving the freshness of the fruit juice squeezed out from a fresh fruit for a longer storage time. The invention is embodied in a portable vacuumable juicer that is characterized by juice-extracting members and juice-collecting receptacle member having a juice-dispensing spout, that are all air-tightly fitted to each other by a sealing means preferably in a form of an O-ring, allowing said receptacle member to be vacuumized by a vacuumizing means that is preferably a detachable vacuum or air suction pump that engages and communicates with a valve means, preferably a one-way check valve, that is air-tightly fitted into the spout.

The primary object therefore of the present invention is to provide a portable vacuumable juicer that is capable of preventing air contact with the extracted juice stored therein by vacuumization process of the interior space thereof that is achieved through a vacuumizing means, valve means and air-tight sealing means of all which the invention is comprised.

Another object of the present invention is to provide a portable vacuumable juicer that comprises of very simple elements and features such that it is very efficient, practical, and economical to use, manufacture and commercialize.

Other objects and advantages of the present invention will become apparent, understood and appreciated upon reading the following detailed description taken in conjunction with the accompanying drawings, in which:

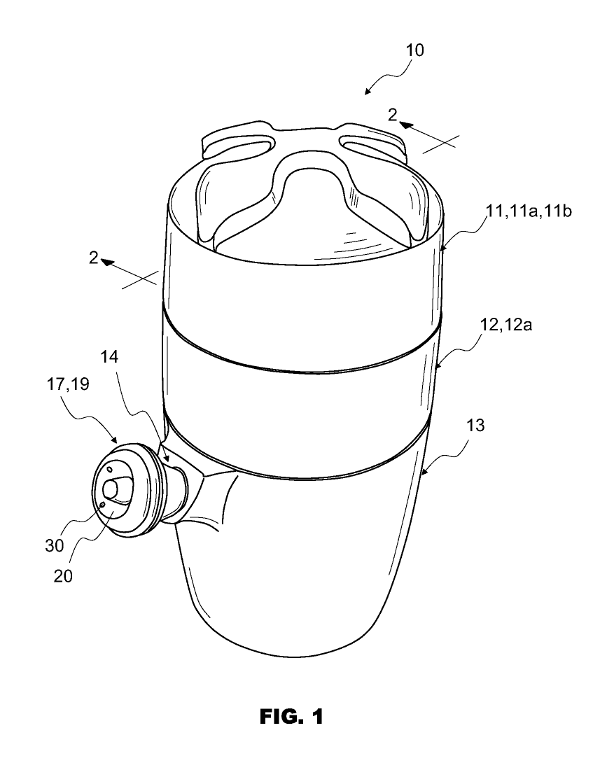

FIG. 1 is a perspective view of a preferred embodiment or illustrative example of the present invention;

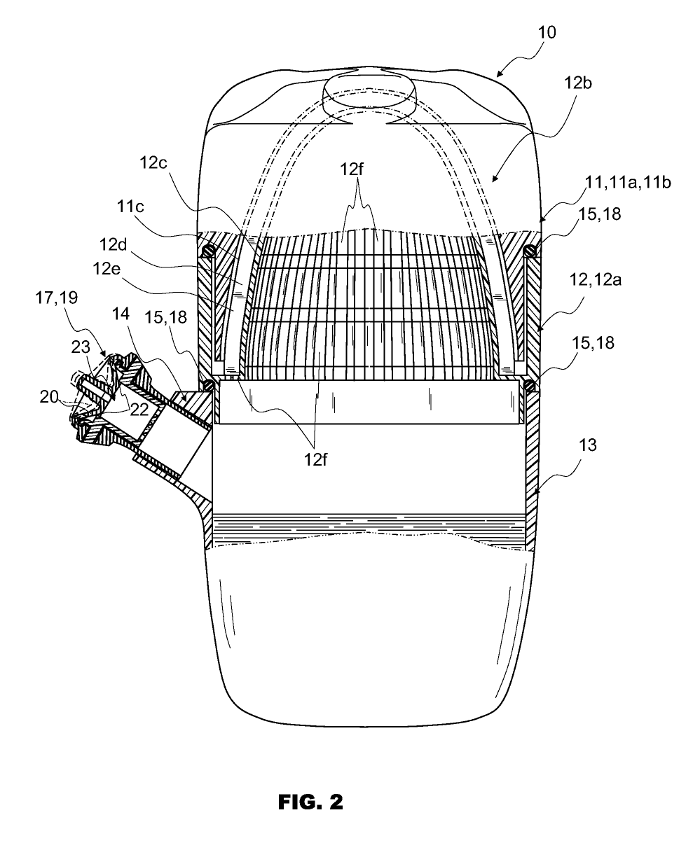

FIG. 2 is a cross-sectional view thereof taken along line 2-2 of FIG. 1;

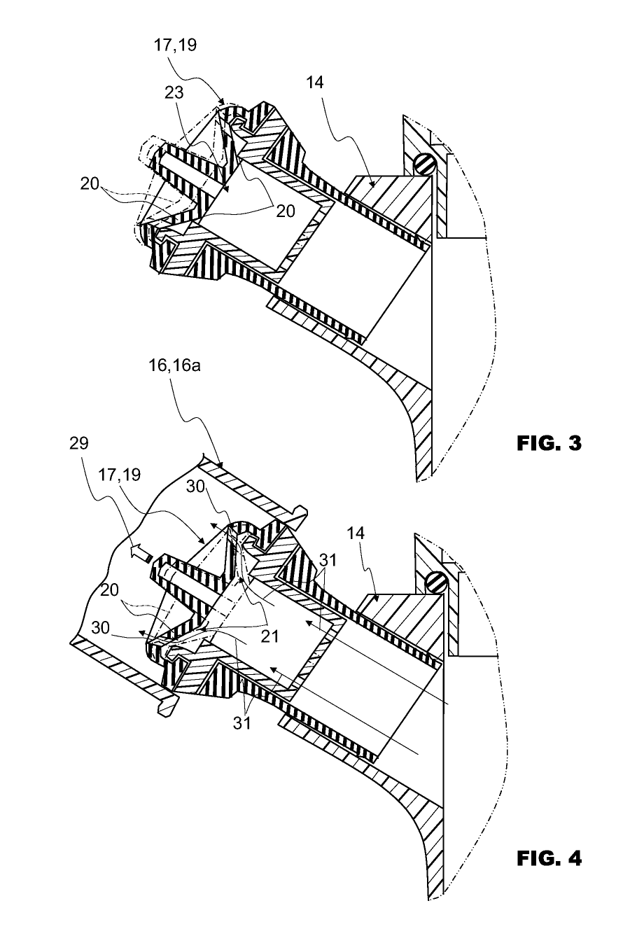

FIG. 3 is an enlarge, cut-away view of an air-suction valve thereof in a close position as referred to FIG. 2;

FIG. 4 is an enlarge, cut-away view of an air-suction valve thereof in an open position as referred to FIG. 2;

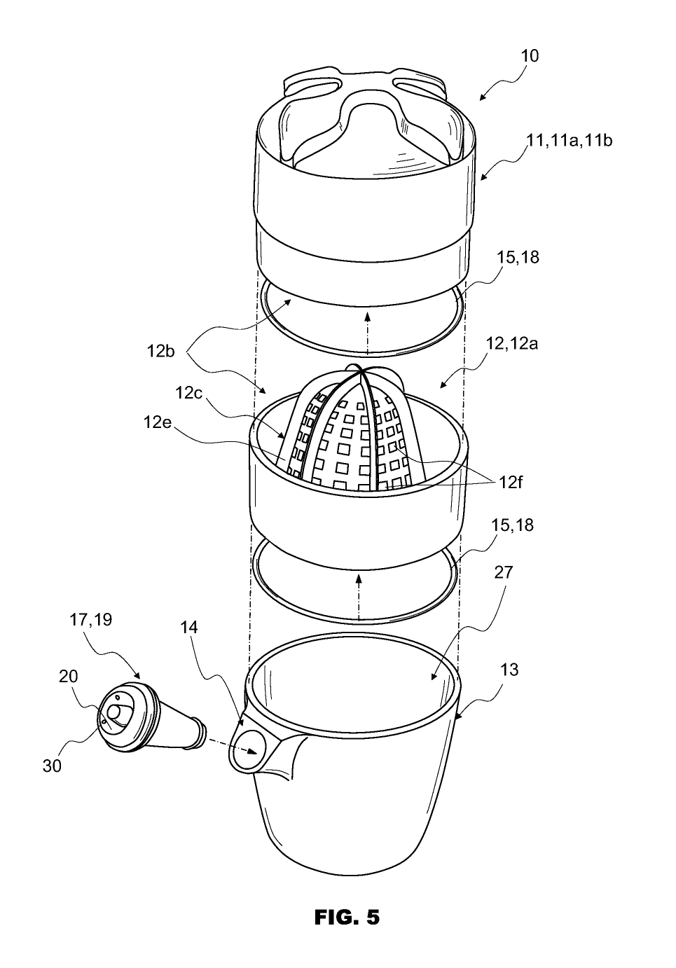

FIG. 5 is an exploded, perspective view thereof;

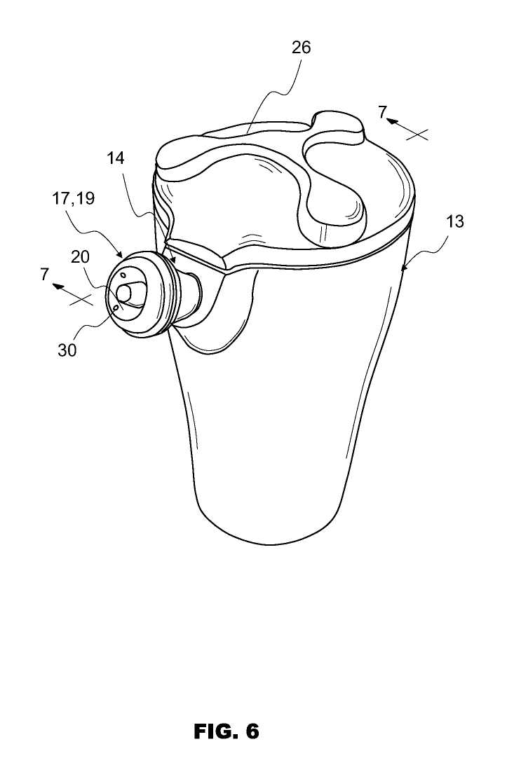

FIG. 6 is a perspective view of another illustrative example of the invention;

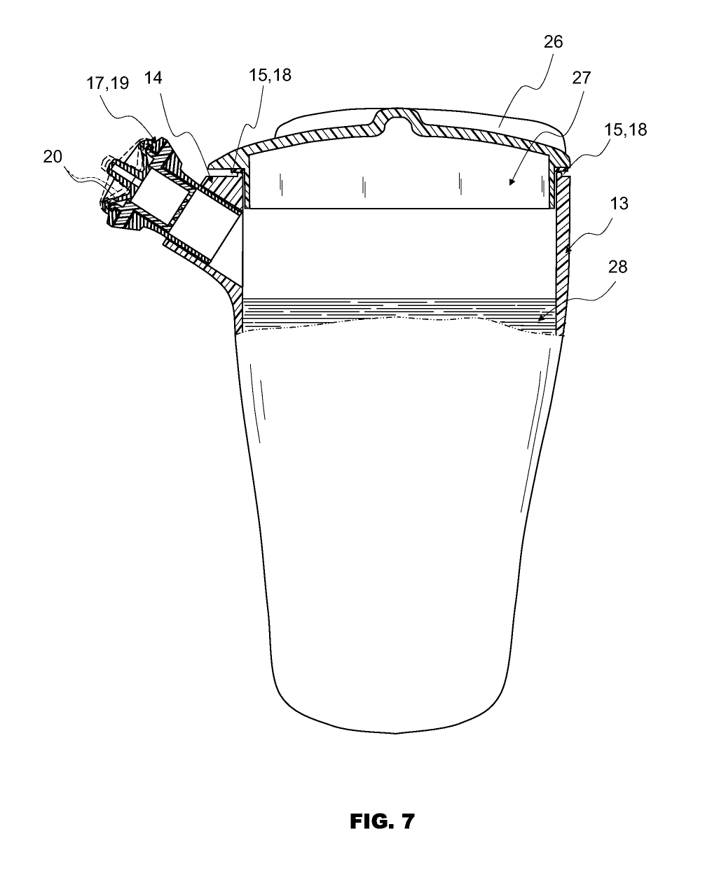

FIG. 7 is a cross-sectional view thereof taken along line 7-7 of FIG. 6; and

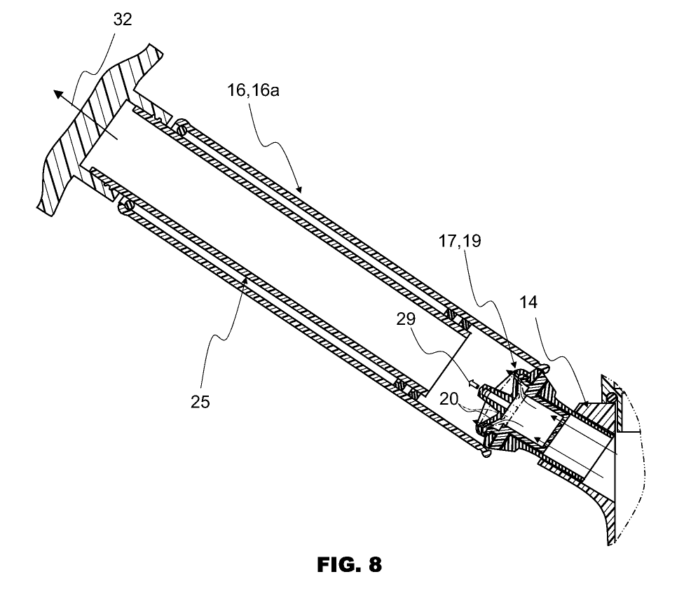

FIG. 8 is a cross-sectional view of a vacuumizing means thereof as air-tightly attached to a valve means thereof.

### DETAILED DESCRIPTION OF THE INVENTION

In describing herein the preferred embodiment or illustrative example of the invention in detail, it is to be understood that the phraseologies and terminologies employed herein are for purposes of description and disclosure only to illustrate the teaching, principle and best operational mode of the invention, thus, should not be regarded as limiting its scope.

Referring now to the drawings in which like reference numerals designate the same components or elements all throughout the succeeding description, there is shown in FIG. 1 a portable vacuumable juicer 10 comprising complementing juice-extracting squeezing or pressing members 11,12 fitted together one on top of the other in assembly and stably engaged onto a juice-collecting receptacle member 13 having a juice-dispensing spout 14. Preferably, the complementing members 11,12 are shown in the illustrative example as upper female and lower male squeezing members 11a,12a, respectively, defining an upper compartment or chamber assembly 12b that is fitted or seated on the juice-collecting receptacle member 13. The female member 11a serving as a cap or covering 11b of the juicer 10 has a generally concave or conical hollow interior 11c that engages or communicates with a similarly shaped or profiled upstanding projecting part 12c of the lower male member 12a such that a pre-determined space or clearance 12d is defined therebetween. The hollow interior 11c and projecting part 12c respectively of the female and male squeezing members 11a,12a have opposing surface ribs 12e functioning as juice extractors, and perforations 12f serving as strainers allowing the juice 28 to pass through during the squeezing or juice extracting process and fall by gravity into to the juice-collecting receptacle member 13. The space or clearance 12d accommodates the items to be squeezed like fruit or vegetable slices that are forcibly compressed and twisted against the squeezing members 11a,12a in order to extract the juice 28 therefrom. The juice-collecting receptacle member 13 is provided with the spout 14 through which the juice 28 can be poured out in usage.

The characterizing elements and features of the present invention are herein described in detail in that the juice-extracting members 11,12 and juice-collecting receptacle member 13 are all air-tightly fitted to each other by a sealing means 15, allowing said receptacle member 13 to be vacuumized by a vacuumizing means 16 that engages and communicates with a valve means 17 air-tightly fitted into the spout 14. The sealing means 15 is preferably in a form of an O-ring 18 made of a material such as rubber, plastic, composite material or any suitable material having an air-tight sealing capacity or property. The valve means 17 is preferably a one-way plug-type check valve 19 as shown clearly in detail in FIGS. 2-4 that communicates with the vacuumizing means 16 in a manner that the air occupying juicer 10 during the juice-extraction process is evacuated out therefrom. On the other hand, the surrounding air is likewise prevented from re-entering into the juicer through the valve 19 or spout 14.

The valve 19 comprises of an integral suction pressure-responsive diaphragm element 20 that is actuated or pulled outwardly by the suction pressure exerted by said vacuumizing means 16 as shown by an arrow 29 in FIGS. 4 and 8 defining an air opening 21. As shown in FIG. 4, this opening 21 in communication with holes 30 provided on the diaphragm element 20 is for the passage of the air evacuated as shown by an arrow 31 from the receptacle member 13. When no suction pressure is exerted by the vacuumizing means, the element 20 automatically returns to its normal closed position, air-tightly abutting against the circumferential edge 22 of the valve's upper end opening 23, thus, preventing air entry or re-entry into the spout 14 as shown in FIG. 3.

The vacuumizing means 16 is preferably in a form of a detachable vacuum or air suction pump 16a which can be a mechanical, electric or pneumatic pump, or combination of these types of vacuum pumps. This vacuum or air suction pump 16a is shown in FIG. 8 as a mechanical type, hand-held detachable peripheral pump having an air-suction piston and cylinder mechanism 25. The pump 16a is air-tightly fitted into the valve means 17 or check valve 19. Pulling out the piston 25a as shown by an arrow 32 suctions out the air (shown by the arrow 31 in FIG. 4) from the member 13 through the opening 21 defined or produced by the pressure-actuated pulled-out diaphragm 20 as shown in FIGS. 4 and 8. Before the piston's inward return stroke with no more suction pressure exerted but pushing/pressing pressure, the diaphragm 20 has already automatically returned to its normal closed position due to its spring or elastic action, it being made preferably of rubber material, preventing the entry or re-entry of air through the opening 21, thus, vacuumizing the member 13.

When the squeezing members 11,12 are not in use with the female squeezing member 11a as covering 11b for juice storage purposes, a separate cover 26 is air-tightly fitted into the open top portion 27 of the receptacle member 13 which can be of any sizes desired depending on the quantity of the juice 28 to be stored.

Unlike the conventional fruit juicers or the components which are non-airtight wherein the extracted juice 28 in the juice-collecting member or receptacle is directly in contact with the surrounding air, the present invention as illustrated or embodied herein in the juicer 10 described in detail with reference to the drawings shown does not allow air contact with the extracted juice 28 which is in storage awaiting to be consumed. With the invention, air contamination or oxidation process is prevented to occur, hence, the freshness, taste and nutrients of the stored extracted juice 28 is preserved. It should be noted that when the juice 28 is being oxidized by the presence of or contact with air in storage, it is not desirable to drink anymore, not only due to bad or sour taste, but more importantly due to its becoming a health hazard with the presence of bacterial or viral contaminant therein. With the present invention all these adverse effects of an air-contaminated or oxidized extracted juice are readily avoided.

Before defining the scope of the following claims, it is to be understood that the invention is not limited in its applications and embodiments to the details of the illustrative example herein disclosed and described with reference to the appended drawings. It is to be noted that the invention is capable of other embodiments, examples and limitless applications not disclosed herein, and of being practiced and carried out in various ways falling within the teaching and scope of the following claims.

What is claimed is:

1. A portable vacuumable juicer comprising complementing juice-extracting squeezing or pressing members (11,12) fitted together in assembly and stably engaged onto a juice-collecting receptacle member (13) having a juice-dispensing spout (14); characterized in that said juice-extracting members (11,12) and juice-collecting receptacle member (13) are all air-tightly fitted to each other by a sealing means (15), allowing said receptacle member (13) to be vacuumized by a vacuumizing means (16) that engages and communicates with a valve means (17) air-tightly fitted into said spout (14).

2. A juicer according to claim 1 wherein said sealing means (15) is in a form of an O-ring (18) made of a material selected from rubber, plastic, and composite material.

3. A juicer according to claim 1 wherein said valve means (17) is a one-way plug-type check valve (19) communicating with said vacuumizing means (16) in a manner that the air occupying said juicer during the juice-extraction process is evacuated out therefrom, and the surrounding air is prevented from re-entering thereinto.

4. A juicer according to claim 3 wherein said valve (19) comprises of an integral suction pressure-responsive diaphragm element (20) that is actuated or pulled outwardly by the suction pressure exerted by said vacuumizing means (16) defining an air opening (21) for passage of the air evacuated from the receptacle member (13), and automatically returns, when no suction pressure is exerted, to its normal closed position, air-tightly abutting against the circumferential edge (22) of the valve's upper end opening (23), preventing air entry or re-entry into said spout (14).

5. A juicer according to claim 1 or 3 wherein said vacuumizing means (16) is in a form of a detachable vacuum or air suction pump (16a) selected from mechanical, electric, pneumatic, and combination thereof.

6. A juicer according to claim 5 wherein said vacuum or air suction pump (16a) that is of a mechanical type is a hand-held detachable peripheral pump having an air-suction piston and cylinder mechanism (25), that is air-tightly fitted into said valve means (17).

7. A juicer according to claim 1 wherein there is provided a peripheral cover (26) air-tightly fitted into the open top portion (27) of said receptacle member (13) when said squeezing members (11,12) are not used for juice storage purposes.
